(19) United States
(12) Patent Application Publication
(10) Pub. No.: US 2026/0264740 A1
(43) Pub. Date: Sep. 10, 2026

(54) STEERING COLUMN RAKE LOCKING ASSEMBLY

(71) Applicant: Steering Solutions IP Holding Corporation, Saginaw, MI (US)

(72) Inventors: Bruce D. Kniebbe, Birch Run, MI (US); Joen C. Bodtker, Flint, MI (US)

(21) Appl. No.: 19/553,613

(22) Filed: Mar. 2, 2026

Related U.S. Application Data
(60) Provisional application No. 63/767,675, filed on Mar. 6, 2025.

(51) Int. Cl. B62D 1/184

(52) U.S. Cl. CPC B62D 1/184

(57) ABSTRACT

A steer-by-wire steering system includes a mounting bracket configured to be fixed to a vehicle structure. The system also includes a column structure operatively coupled to the mounting bracket and adjustable in a rake direction. The system further includes a rake bracket operatively coupled to the column structure. The system yet further includes a rake lock assembly for switching between a locked and unlocked condition for a position of the column structure relative to the mounting bracket, the rake lock assembly comprising a locking bar having a plurality of teeth, the locking bar extending through a pair of parallel slots defined by the mounting bracket and through a slot defined by the rake bracket, wherein the plurality of teeth of the locking bar are moveable into and out of engagement with a plurality of teeth disposed on the rake bracket to switch between the locked and unlocked condition.

### CROSS-REFERENCE TO RELATED APPLICATION

This application claims the benefits of priority to U.S. Provisional Patent Application Serial No. 63/767,675, filed Mar. 6, 2025, the disclosure of which is incorporated by reference herein in its entirety.

### FIELD OF THE INVENTION

The embodiments described herein relate to vehicle steering systems and, more particularly, to a rake locking assembly for a steer-by-wire steering systems.

### BACKGROUND

Different vehicles typically include various steering system designs. Many of the different types of steering systems offer adjustability in the longitudinal direction of the steering column, which may be referred to as translating or telescoping adjustment. Additionally, many systems facilitate adjustment in a substantially upward and downward direction for height adjustability of a steering wheel. Height adjustment is typically based on pivoting at least a portion of the steering column about an axis.

Several types of devices and mechanism have been created to hold or lock the height position after the desired adjustment has been made by an operator. Historical locations of the column pivot are proximate the drive just behind the steering wheel (i.e., tilt) or near the compartment separator (i.e., rake). Tilt columns are always positive lock while rake columns may use either approach. Positive locking systems rely on tooth engagement with an array of teeth located about the pivot bolt axis. Typical rake locking mechanisms rely on friction between plates along the rake bolt axis. Regardless of the type of lock system utilized, holding load requirements and crash worthiness standards must be met.

### SUMMARY

According to one aspect of the disclosure, a steer-by-wire steering system includes a mounting bracket configured to be fixed to a vehicle structure. The steering system also includes a column structure operatively coupled to the mounting bracket and adjustable in a rake direction, relative to the mounting bracket. The steering system further includes a rake bracket operatively coupled to the column structure. The steering system yet further includes a rake lock assembly for switching between a locked condition and an unlocked condition for a position of the column structure relative to the mounting bracket, the rake lock assembly comprising a locking bar having a plurality of teeth, the locking bar extending through a pair of parallel slots defined by the mounting bracket and through a slot defined by the rake bracket, wherein the plurality of teeth of the locking bar are moveable into and out of engagement with a plurality of teeth disposed on the rake bracket to switch between the locked condition and the unlocked condition.

According to another aspect of the disclosure, a steer-by-wire steering system includes a steering shaft coupleable to a steering input device at a first end of the steering shaft. The steering system also includes a column structure, wherein the steering shaft is at least partially disposed within the column structure. The steering system further includes a rake bracket disposed on an opposite side of the column structure, relative to the first end of the steering shaft. The steering system yet further includes a mounting bracket configured to be fixed to a vehicle structure, wherein the steering shaft, the column structure and the rake bracket are adjustable relative to the mounting bracket. The steering system also includes a rake lock assembly to manually switch between a locked condition and an unlocked condition for a position of the steering shaft, the column structure, and the rake bracket, relative to the mounting bracket. The rake lock assembly includes an adjustment lever having a lever opening. The rake lock assembly also includes a release link having a link opening. The rake lock assembly further includes a rake bolt extending through the lever opening, the link opening and a first pair of parallel slots defined by the mounting bracket. The rake lock assembly yet further includes a locking bar having a plurality of teeth, the locking bar extending through a second pair of parallel slots defined by the mounting bracket and through a slot defined by the rake bracket, wherein the plurality of teeth of the locking bar are moveable into and out of engagement with a plurality of teeth disposed on the rake bracket to switch between the locked condition and the unlocked condition for the position of the steering shaft, the column structure, and the rake bracket, relative to the mounting bracket.

These and other advantages and features will become more apparent from the following description taken in conjunction with the drawings.

### BRIEF DESCRIPTION OF THE DRAWINGS

The subject matter that is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a front, first side perspective view of a steering column assembly having a rake locking mechanism.

FIG. 2 is a front, second side perspective view of the steering column assembly.

FIG. 3 is a rear perspective view of the steering column assembly.

FIG. 4 is a disassembled view of the steering column assembly.

FIG. 5 is an elevational view of the rake locking mechanism in a locked condition.

FIG. 6 is an elevational view of the rake locking mechanism in an unlocked condition.

### DETAILED DESCRIPTION

The following discussion is directed to various embodiments of the disclosure. Although one or more of these embodiments may be described in more detail than others, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable vehicles, include various steering system schemes, for example, autonomous or semi-autonomous steering modes, steer-by-wire systems and driver interface steering. These steering system schemes typically include a steering column for translating steering input to an output that interacts with a steering linkage to ultimately cause the vehicle wheels (or other elements) to turn the vehicle. The embodiments of the steering system disclosed herein include a steering column structure with a rake locking assembly. The steering system is a steer-by-wire system. In such a system, a traditional intermediate shaft which is part of a continuous mechanical connection between a steering wheel and road wheels is not needed. Therefore, space exists where the intermediate shaft was previously typically present.

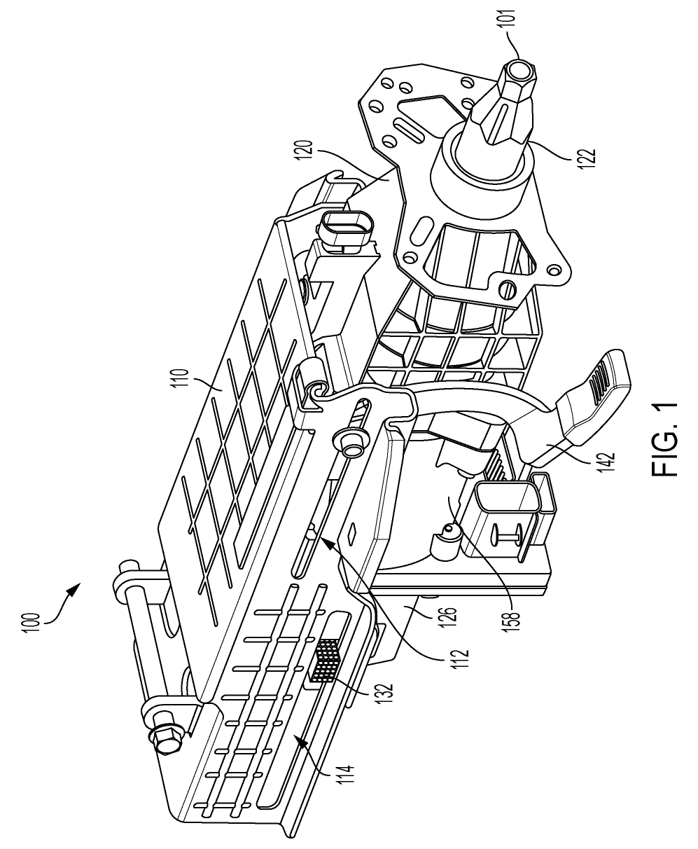

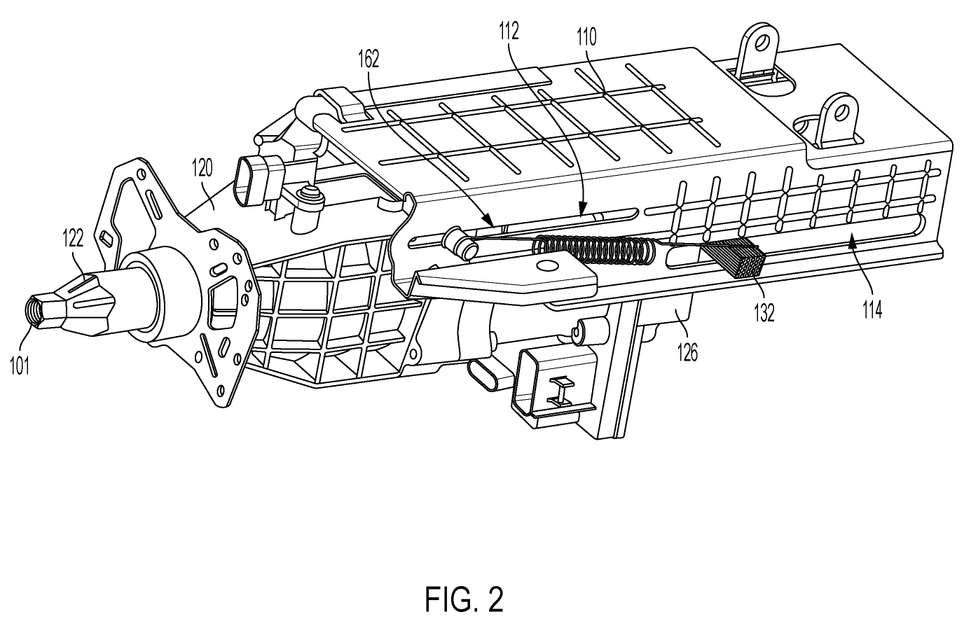

Referring to FIGS. 1-4, various portions and perspectives of a steer‑by‑wire steering system 100 are shown. The steering system 100 includes a column structure 120 that supports a steering shaft 122 configured to be coupleable to a steering input device (not shown), such as a steering wheel, at a first end 101 of the steering shaft. In a steer‑by‑wire configuration a continuous mechanical connection from the steering input device to the road wheels is not required, which provides additional packaging space around the steering column. The column structure 120 is carried by a mounting bracket 110 that is configured to be fixed to a vehicle structure (not shown). The column structure 120 is adjustable in a rake direction A, relative to the mounting bracket 110 and about a pivot established at a pivot bolt 162 disposed in a rake‑in‑vehicle pivot location, shown in FIG. 2.

A rake bracket 126 is disposed adjacent a lower region (i.e., forward in vehicle) of the column structure 120, generally opposite the steering input device, and is fastened to the column structure 120 so that the rake bracket 126 moves with the column structure 120 in the rake direction A. The mounting bracket 110 defines two distinct sets of elongated guide features. In particular, the mounting bracket defines a first pair of parallel slots 112 and a second pair of parallel slots 114. The first pair of parallel slots 112 receives and guides a rake bolt 140 associated with a manual adjustment lever 142 and a release link 136. A second pair of parallel slots 114 receives and guides a locking bar 132 that forms part of a rake lock assembly 130. The rake bracket 126 defines an arcuate slot 127 which overlaps with the second pair of parallel slots 114 to allow passage of the locking bar 132 therethrough. The rake bracket 126 further includes a first set of locking teeth 128 and a second set of locking teeth 129.

The rake lock assembly 130 is configured to selectively lock the column structure 120 and the rake bracket 126 in a desired rake position relative to the mounting bracket 110 by switching between a locked condition and an unlocked condition. The assembly 130 includes the locking bar 132. The locking bar 132 includes a first plurality of bar teeth 134 on a first side of the locking bar 132 sized and shaped to mesh with the first set of locking teeth 128 on the rake bracket 126. The locking bar 132 also includes a second plurality of bar teeth 135 on a second side of the locking bar 132 sized and shaped to mesh with the second set of locking teeth 129 on the rake bracket 126. The locking bar 132 extends laterally across the system 100 (i.e., transverse to longitudinal direction of mounting bracket 110 and column structure 120) and through the second pair of parallel slots 114 of the mounting bracket 110 and through the arcuate slot 127 of the rake bracket 126. The locking bar 132 is received in a groove 138 formed in the release link 136, such that the release link 136 controls the fore‑aft position of one side of the locking bar 132 and the angular orientation of the locking bar 132. A tension spring 146 has a first end engaged to the rake bolt 140 and a second end engaged to the locking bar 132, thereby biasing the locking bar 132 in a direction that urges the bar teeth 134, 135 into meshing engagement with the locking teeth 128, 129 of the rake bracket 126.

The adjustment lever 142 is pivotably mounted to the system 100 about the rake bolt 140 and includes an integral cam 144 that bears against a cam follower surface of the release link 136. The release link 136 includes a link opening 137 that is larger than the diameter of the rake bolt 140 so that the release link 136 can translate forward and rearward relative to the mounting bracket 110 when driven by the cam 144, while the rake bolt 140 remains guided in the first pair of parallel slots 112. In the illustrated embodiment the spring 146 is disposed along a first side of the mounting bracket 110, and the release link 136 is disposed along a second side of the mounting bracket 110 that is opposite to the first side of the mounting bracket 110. While the spring 146 is shown outboard of the first side of the mounting bracket 110 and the release link 136 is shown as extending inboard of the second side of the mounting bracket, it is to be appreciate that some embodiments may have the spring 146 inboard of the mounting bracket and the release link 136 outboard of the mounting bracket 110 in any combination.

FIG. 1 shows the overall arrangement of the mounting bracket 110, the first and second pairs of parallel slots 112, 114, and the manual adjustment lever 142. FIG. 2 illustrates the pivot bolt 162 establishing the rake pivot and the spring 146 that biases the locking bar 132 toward engagement. In one implementation the pivot bolt 162 may pass through a pair of rake cams 170 affixed to the column structure 120 to define fixed stop surfaces that cooperate with the mounting bracket 110 to limit the angular travel of the column structure in rake.

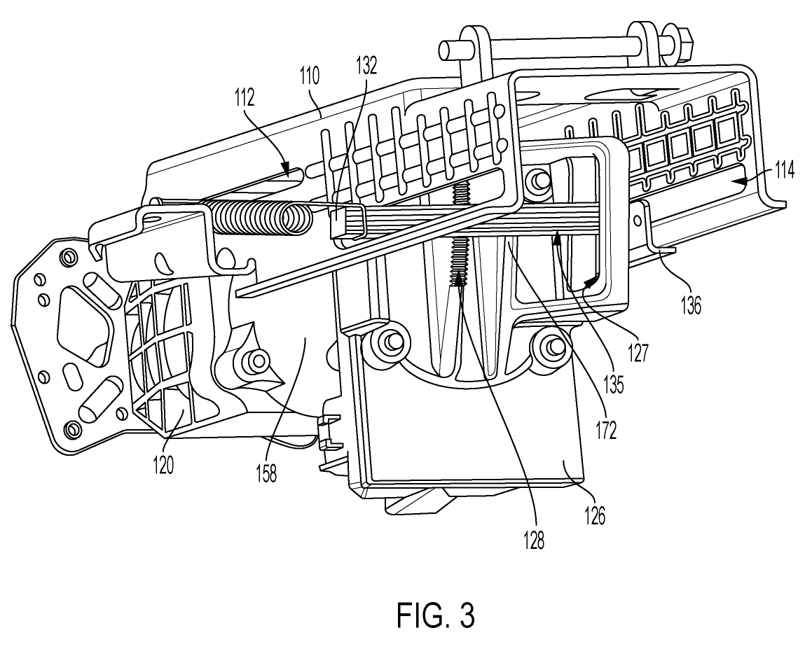

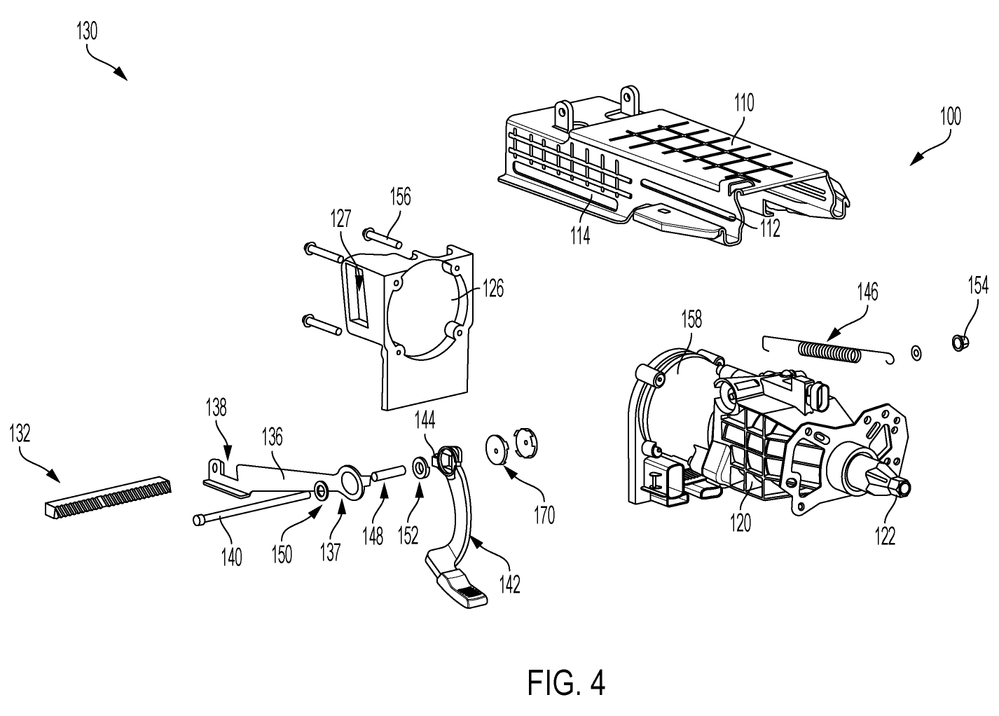

FIG. 3 depicts the relationship between the release link 136, the locking bar 132, and the rake bracket 126, as well as the relationship between the spring 146, the locking bar 132 and the rake bracket 126. As shown in FIGS. 4-6, the groove 138 in the release link 136 is sized to have the locking bar 132 seated therein and provides controlled pivoting movement of the locking bar 132 about a fulcrum 172 that projects from the rake bracket 126. When the release link 136 is driven by the cam 144, the locking bar 132 pivots about the fulcrum 172 to withdraw the bar teeth 134, 135 from their respective associated locking teeth 128, 129 of the rake bracket 126. As shown, the locking teeth 128, 129 of the rake bracket 126 face in opposite directions, such that the bar teeth 134, 135 – which are on opposite sides of the locking bar 132 – engage the locking teeth 128, 129 when pivoting motion of the locking bar 132 is made about the fulcrum 172 of the rake bracket 126.

FIG. 4 presents a disassembled view of the system 100. The mounting bracket 110 receives the column structure 120. The rake bracket 126 is attached to the column structure 120 with fasteners such as screws, bolts or the like 156. The rake bolt 140 passes through a thrust bearing 152, through the adjustment lever 142, a washer 150, and a thimble 148 that guides the rake bolt through the release link 136 and the first pair of parallel slots 112, and is secured by a lock nut 154. The locking bar 132 is slid through the second pair of parallel slots 114 and through the arcuate slot 127 in the rake bracket 126 until seated in the groove 138 of the release link 136. The spring 146 is then hooked between a feature on the locking bar 132 and a feature on the rake bolt 140 to energize the locking bar toward engagement.

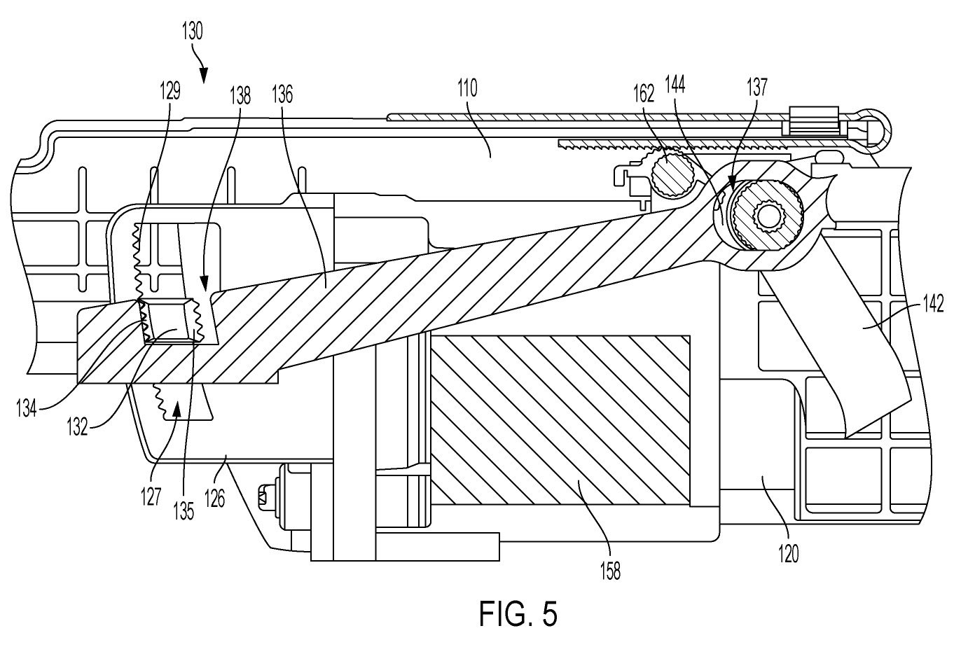

FIG. 5 shows the locked condition 180 in which the cam 144 on the lever 142 allows the release link 136 to be driven rearward by the spring 146. Rearward motion of the release link 136 urges the locking bar 132 to pivot about the fulcrum 172 so that the bar teeth 134, 135 to mesh with the locking teeth 128, 129 on the rake bracket 126. In this condition the rake bracket 126 is positively retained relative to the mounting bracket 110, preventing rake movement of the column structure 120. Holding loads from driver inputs and crash forces are reacted through the locking bar 132 into the mounting bracket 110, with the opposed pairs of slots 112 and 114 acting as shear guides for the rake bolt 140 and the locking bar 132.

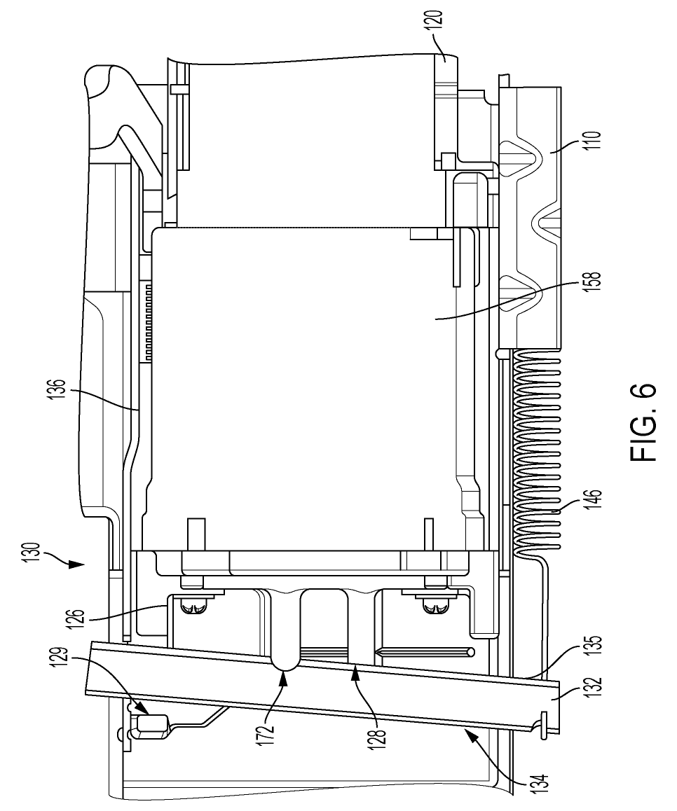

FIG. 6 shows the unlocked condition 182. When the operator lifts or otherwise actuates the adjustment lever 142, the cam 144 urges the release link 136 to overcome the biasing force of the spring 146. Motion of the release link 136 causes the locking bar 132 to pivot about the fulcrum 172, thereby withdrawing the bar teeth 134, 135 from the locking teeth 128, 129. With the teeth disengaged, the rake bracket 126 is free to move relative to the mounting bracket 110 as the column structure 120 pivots about the pivot bolt 162. The geometry of the groove 138 and the positions of the fulcrum locations 172 are selected so that minimal operator effort produces reliable and repeatable disengagement while maintaining robust tooth engagement when released.

In certain embodiments an electric actuator 158 may be disposed between the column structure 120 and the rake bracket 126 to provide steering assistance and road feedback to the driver via the steering shaft.

The tooth geometry of the bar teeth 134, 135 and the locking teeth 128, 129 may be tailored to achieve high load capacity and low wear. In one example the teeth are arranged along an arcuate path having a center substantially coincident with the pivot bolt 162 so that engagement depth remains constant over the rake range. The bar teeth 134 may be formed with a slight negative pressure angle to resist cam‑out under crash loads. The locking bar 132 may be a powdered metal or forged steel component heat treated for surface hardness, while the rake bracket 126 may be a steel stamping with a hardened insert defining the locking teeth 128, 129.

The mounting bracket 110 may be a sheet‑metal structure with locally embossed rails around the first and second pairs of parallel slots 112 and 114 to resist deformation under shear loads. The release link 136 may be a stamped and formed steel member with the groove 138. The lever 142 may be a die‑cast or forged component with the cam 144 formed as an integral feature for durability. The thrust bearing 152 reduces operating effort around the rake bolt 140 and prevents galling between the lever 142 and adjacent components.

In operation the user moves the adjustment lever 142 to the unlocked position 182, which through the cam 144 shifts the release link 136 and pivots the locking bar 132 out of engagement with the locking teeth 128. The column structure 120 is then free to rotate about the pivot bolt 162 to a desired rake position while the rake bolt 140 and the locking bar 132 translate within their respective parallel slots 112 and 114. Releasing the lever 142 allows the spring 146 to pull the release link 136, pivoting the locking bar 132 into engagement to establish the locked condition 180. The opposed tooth sets 128, 134 provide a positive mechanical lock that resists movement without reliance on frictional clamping, thereby achieving consistent performance over temperature, wear, and tolerance variations.

Although specific structures and part numbers are shown in the figures, equivalent components may be substituted without departing from the scope described herein. The features described for one embodiment may be combined with features of other embodiments to produce additional variations

While the invention has been described in detail in connection with only a limited number of embodiments, it is to be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Moreover, any feature, element, component or advantage of any one embodiment can be used on any of the other embodiments. Accordingly, the invention is not to be seen as limited by the foregoing description.

What is claimed is:

1. A steer-by-wire steering system comprising:
a mounting bracket configured to be fixed to a vehicle structure;
a column structure operatively coupled to the mounting bracket and adjustable in a rake direction, relative to the mounting bracket;
a rake bracket operatively coupled to the column structure; and
a rake lock assembly for switching between a locked condition and an unlocked condition for a position of the column structure relative to the mounting bracket, the rake lock assembly comprising a locking bar having a plurality of teeth, the locking bar extending through a pair of parallel slots defined by the mounting bracket and through a slot defined by the rake bracket, wherein the plurality of teeth of the locking bar are moveable into and out of engagement with a plurality of teeth disposed on the rake bracket to switch between the locked condition and the unlocked condition.

2. The steer-by-wire steering system of claim 1, wherein the locking bar is seated in a groove defined by a release link.

3. The steer-by-wire steering system of claim 1, wherein the locking bar pivots into and out of engagement with the plurality of teeth disposed on the rake bracket in response to movement of a release link.

4. The steer-by-wire steering system of claim 2, further comprising a manual adjustment lever operatively coupled to the locking bar to move the locking bar between the locked condition and the unlocked condition.

5. The steer-by-wire steering system of claim 4, further comprising:
a rake bolt operatively coupled to the adjustment lever; and
a spring operatively coupled to a rake bolt at a first end of the spring and to the locking bar at a second end of the spring.

6. The steer-by-wire steering system of claim 5, wherein the spring is configured to bias the locking bar toward engagement with the plurality of teeth disposed on the rake bracket.

7. The steer-by-wire steering system of claim 5, wherein the spring extends along a first side of the mounting bracket and the release link extends along a second side of the mounting bracket.

8. The steer-by-wire steering system of claim 1, further comprising an electric actuator operatively coupled to the column structure, wherein the electric actuator is disposed between the column structure and the rake bracket.

9. A steer-by-wire steering system comprising:
a steering shaft coupleable to a steering input device at a first end of the steering shaft;
a column structure, wherein the steering shaft is at least partially disposed within the column structure;
a rake bracket disposed on an opposite side of the column structure, relative to the first end of the steering shaft;
a mounting bracket configured to be fixed to a vehicle structure, wherein the steering shaft, the column structure and the rake bracket are adjustable relative to the mounting bracket; and
a rake lock assembly to manually switch between a locked condition and an unlocked condition for a position of the steering shaft, the column structure, and the rake bracket, relative to the mounting bracket, the rake lock assembly comprising:
an adjustment lever having a lever opening;
a release link having a link opening;
a rake bolt extending through the lever opening, the link opening and a first pair of parallel slots defined by the mounting bracket;
a locking bar having a plurality of teeth, the locking bar extending through a second pair of parallel slots defined by the mounting bracket and through a slot defined by the rake bracket, wherein the plurality of teeth of the locking bar are moveable into and out of engagement with a plurality of teeth disposed on the rake bracket to switch between the locked condition and the unlocked condition for the position of the steering shaft, the column structure, and the rake bracket, relative to the mounting bracket.

10. The steer-by-wire steering system of claim 9, wherein the link opening of the release link is larger than a diameter of the rake bolt to permit relative movement between the release link and the rake bolt.

11. The steer-by-wire steering system of claim 9, wherein the adjustment lever comprises a cam configured to bias the release link in a forward and back direction.

12. The steer-by-wire steering system of claim 9, wherein the locking bar is seated in a groove defined by the release link.

13. The steer-by-wire steering system of claim 12, wherein movement of the release link in a forward direction and a rearward direction, relative to the longitudinal direction of the mounting bracket, biases the locking bar into and out of the locked condition.

14. The steer-by-wire steering system of claim 9, wherein the locking bar pivots into and out of engagement with the plurality of teeth disposed on the rake bracket in response to movement of the release link.

15. The steer-by-wire steering system of claim 11, wherein the cam is formed as a single unit with the adjustment lever.

16. The steer-by-wire steering system of claim 9, further comprising a spring operatively coupled to the rake bolt at a first end of the spring and to the locking bar at a second end of the spring.

17. The steer-by-wire steering system of claim 16, wherein the spring is configured to bias the locking bar toward engagement with the plurality of teeth disposed on the rake bracket.

18. The steer-by-wire steering system of claim 16, wherein the spring extends along a first side of the mounting bracket and the release link extends along a second side of the mounting bracket.

19. The steer-by-wire steering system of claim 9, further comprising an electric actuator operatively coupled to the column structure, wherein the electric actuator is disposed between the column structure and the rake bracket.
